(19) United States
(12) Patent Application Publication
(10) Pub. No.: US 2015/0365804 A1
(43) Pub. Date: Dec. 17, 2015

(54) Positioning Capability Based Assistance Data Generation

(71) Applicant: QUALCOMM Incorporated, San Diego, CA (US)

(72) Inventors: Jiajian CHEN, San Jose, CA (US); Yin Chen, Campbell, CA (US); Hui Chao, San Jose, CA (US); Ravi Palanki, Cupertino, CA (US)

(21) Appl. No.: 14/303,532

(22) Filed: Jun. 12, 2014

(51) Int. Cl. H04W 4/04; H04W 64/00

(52) U.S. Cl. CPC H04W 4/043; H04W 64/006

(57) ABSTRACT

Methods and apparatuses of providing assistance data of a venue to a mobile device are disclosed. According to aspects of the present disclosure, one approach is to compute a visibility area that may satisfy positioning criteria for a venue, for example a mobile device may observe sufficient signals for positioning in the visibility area. Then, positioning assistance data may be generated that includes the information of signal characteristics in this visibility area. With this approach, the size of the positioning assistance data can be reduced and can be used more efficiently for positioning applications without losing useful information.

### FIELD

The present disclosure relates to the field of wireless communications. In particular, the present disclosure relates to methods and apparatuses for generating positioning capability based assistance data.

### BACKGROUND

With the proliferation of mobile devices, it is common for mobile devices to be used both inside and outside of a venue, and to be transitioned from inside to outside or from outside to inside of the venue while being used. For using the mobile devices in indoor environments, it is well known that satellite signals may not be strong enough in some situations to be useful for some applications, and WiFi signals from one or more access points in a venue may be used for such applications. However, the strength of the WiFi signals may decrease as the distance from the one or more access points increases. For outdoor environments near some venues, such as among or near tall buildings, it is also well known that there may be poor satellite signal reception in some situations. These situations have presented challenges to ensure smooth transition between indoor environments and outdoor environments while providing continuing services to the mobile devices. Thus, it would be beneficial to provide methods and apparatuses for positioning based assistance data generation that can address these challenging situations described.

### SUMMARY

Methods and apparatuses for generating positioning capability based assistance data are disclosed. According to aspects of the present disclosure, one approach is to compute a visibility area that may satisfy positioning criteria for a venue, for example a mobile device may observe sufficient signals for positioning in the visibility area. Then, positioning assistance data may be generated that includes the information of signal characteristics in this visibility area. With this approach, the size of the positioning assistance data can be reduced and can be used more efficiently for positioning applications without losing useful information.

In one embodiment, a method of generating a positioning assistance data of a venue may include obtaining a map and corresponding descriptions of one or more access points in the venue, determining a coverage area of the one or more access points based on measurements of signal strength received from the one or more access points within the signal boundary of the venue, and generating the positioning assistance data of the venue using the coverage area of the one or more access points. The venue may have a signal boundary which extends beyond an indoor area of the venue, where the signal boundary may be partitioned into a plurality of grid points, and where each grid point in the plurality of grid points represents an area within the signal boundary of the venue. The coverage area of the one or more access points meets a criterion of signal strength received from at least one access point, and where the coverage area includes some grid points in the indoor area of the venue and some grid points in an outdoor area of the venue.

In another embodiment, an apparatus include one or more processors that include processing logic. The processing logic comprises logic configured to obtain a map and corresponding descriptions of one or more access points in the venue, logic configured to determine a coverage area of the one or more access points based on measurements of signal strength received from the one or more access points within the signal boundary of the venue, and logic configured to generate the positioning assistance data of the venue using the coverage area of the one or more access points.

In yet another embodiment, a computer program product includes non-transitory medium storing instructions for execution by one or more computer systems. The instructions comprise instructions for obtaining a map and corresponding descriptions of one or more access points in the venue, instructions for determining a coverage area of the one or more access points based on measurements of signal strength received from the one or more access points within the signal boundary of the venue, and instructions for generating the positioning assistance data of the venue using the coverage area of the one or more access points.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of following drawings. Like numbers are used throughout the figures.

FIG. 1 illustrates an exemplary venue according to aspects of the present disclosure.

FIG. 2A illustrates an exemplary method of generating a positioning assistance data of a venue according to aspects of the present disclosure.

FIG. 2B illustrates an exemplary method of determining a coverage area of one or more access points according to aspects of the present disclosure.

FIG. 2C illustrates an exemplary method of generating the positioning assistance data of a venue according to aspects of the present disclosure.

FIG. 3A illustrates an exemplary method of computing a signal visibility area of a venue according to aspects of the present disclosure.

FIG. 3B illustrates another exemplary method of computing a signal visibility area of a venue according to aspects of the present disclosure.

FIG. 4A is an exemplary graphical illustration of computing visibility area of a venue according to aspects of the present disclosure.

FIG. 4B is a flowchart of computing visibility area of a venue of FIG. 4A according to aspects of the present disclosure.

FIGS. 5A-5B is another exemplary graphical illustration of computing visibility area of a venue according to aspects of the present disclosure.

FIG. 5C is a flowchart of computing visibility area of a venue of FIGS. 5A-5B according to aspects of the present disclosure.

FIG. 6 illustrates exemplary block diagram of an apparatus that can be configured to generate positioning assistance data of a venue according to aspects of the present disclosure.

FIG. 7 illustrates another exemplary block diagram of an apparatus that can be configured to generate positioning assistance data of a venue according to aspects of the present disclosure.

### DESCRIPTION OF EMBODIMENTS

Embodiments of generating positioning capability based assistance data of a venue are disclosed. The following descriptions are presented to enable a person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the widest scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

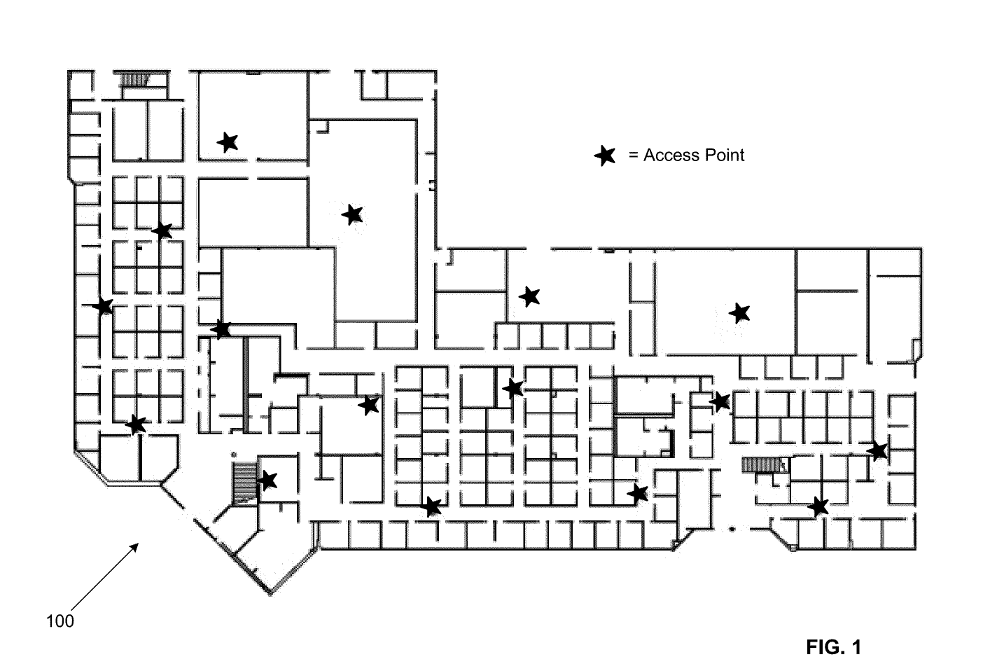

FIG. 1 illustrates an exemplary venue according to aspects of the present disclosure. In this example, a venue, such as venue 100, may provide characteristics of its indoor and/or outdoor environments. For example, schematic maps of indoor/outdoor environments of the venue, together with locations of access points may be obtained. More specifically, one or more schematic maps or other indoor/outdoor environment characteristics may be provided to a mobile device in the form of positioning assistance data.

In example implementations, a venue, such as venue 100, may comprise one or more indoor areas such as office buildings, shopping malls, airports, apartment buildings, arenas, convention centers, auditoriums, amphitheaters, warehouses, classroom buildings, supermarkets, stadiums, a transit station terminal, a library, one or more floors thereof, interiors of other structures, or any combination thereof, just to name a few examples. In example implementations, indoor environment characteristics may be descriptive of the exemplary indoor environment and may facilitate providing a location-based service, examples of which are described below. By way of example but not limitation, indoor environment characteristics may include one or more of any of the following: a schematic map, a connectivity graph for a schematic map, a routing graph for a schematic map, annotation information for a schematic map, points of interest for an indoor environment, navigational instructions, or any combination thereof, etc. The one or more access points may be located internal to the venue 100, or alternatively they may also be located fully or partially external to the venue 100.

In addition, a venue may refer to a physical place or locale that may be associated with the whereabouts of an object or thing (e.g., a user, or a mobile device, etc.) according to a desired or suitable point of reference represented, for example, via geographic coordinates (e.g., latitude, longitude, etc.), a street address, a governmental jurisdiction, a postal zip code, a name, or any combination thereof, etc. Depending on the particular implementation, a venue may comprise, for example, various partially or substantially enclosed areas associated with an indoor environment, as shown in FIG. 1.

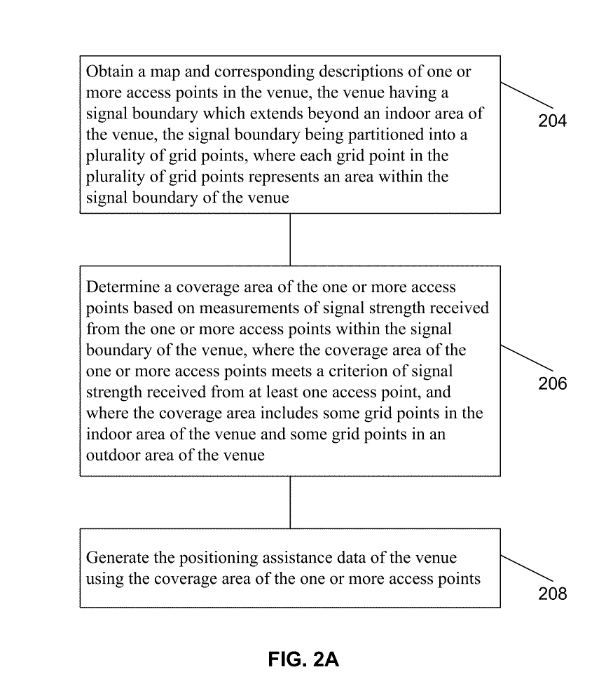

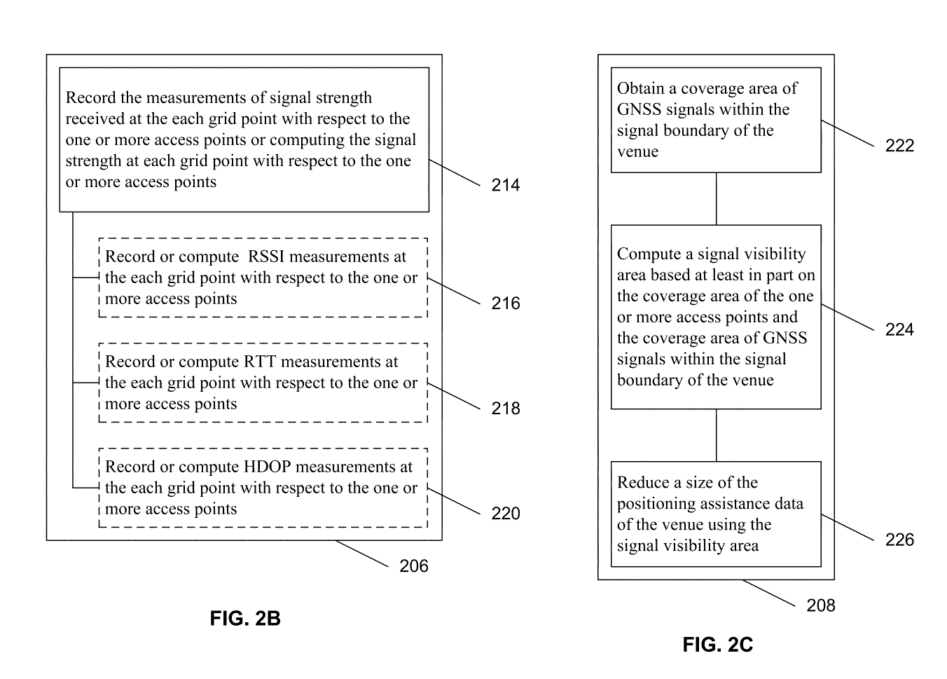

FIG. 2A illustrates an exemplary method of generating a positioning assistance data of a venue according to aspects of the present disclosure. In the example shown in FIG. 2A, in block 204, the method obtains a map and corresponding descriptions of one or more access points in the venue, where the venue having a signal boundary which extends beyond an indoor area of the venue, where the signal boundary being partitioned into a plurality of grid points, and where each grid point in the plurality of grid points represents an area within the signal boundary of the venue. In some implementations, the signal boundary may be further based on a radius of WiFi signals from each of the one or more access points in the venue.

According to aspects of the present disclosure, a map of a venue may include, but are not limited to, walls, doors, railings, or columns; furniture or cubicle dividers; elevators or stairs; or any combination thereof; etc. Detailed information of the venue may exist in the physical world and may have corresponding representation(s) included as part of a schematic map of the venue. Although claimed subject matter is not so limited, detailed information of a venue may thus include building features or other objects of the venue. On the other hand, venues may also have open areas such as lobbies, common areas, entryways, or rooms, etc., just to name a few examples.

In some embodiments, each grid point in the plurality of grid points may represent an area within the signal boundary of the venue. According to aspects of the present disclosure, grid points may have a separation of one inch, one foot, or ten feet apart, just to name a few examples. Grid points may also be organized or arranged in any manner. By way of example only, positions may be organized into a grid of points, which may be associated with a local or global coordinate system and laid over a floor plan or other schematic map of a venue at substantially uniform spacing. A scale of a grid of points (e.g., an interval or distance between adjacent points) may be varied based, at least in part, on a desired level of precision for positioning or other location-based services, on an available amount of resources (e.g., memory, processing, etc.), on a size of a schematic map being covered, on any combination thereof, etc. In one particular implementation, grid points may be placed or positioned at sufficiently regular intervals so as to cover, for example, at least a portion of the venue.

According to aspects of the present disclosure, information related to the at least one access point devices may be obtained and provided as positioning assistance data. For example, observations of at least one access point device in the venue can be made; and information observed about the at least one access point device can be compiled. Note that the information observed about the at least one access point device may include, but not limited to, observation time, latitude, longitude, altitude, horizontal uncertainty, and vertical uncertainty. The information observed about the at least one access point device may further include MAC (media access control) address, SSID (service set identifier), RSSI (received signal strength indication), RTT (round-trip time), radio specification and frequency band. The location descriptions may include at least one of GNSS (global navigation satellite system) position measurement information and WiFi position measurement information.

In block 206, the method determines a coverage area of the one or more access points based on measurements of signal strength received from the one or more access points within the signal boundary of the venue. The coverage area of the one or more access points meets a criterion of signal strength received from at least one access point, and the coverage area includes some grid points in the indoor area of the venue and some grid points in an outdoor area of the venue. A measure of signal strength may comprise at least one measured value (e.g., an RSSI value, or an RTT value, etc.) by a mobile device with respect to an access point may enable the mobile device to estimate a range between the mobile device and the access point. An RTT may be derived from, for example, one or more communication exchanges between a mobile device and one or more access point devices in the venue. A measure of signal strength may further comprise, by way of example only, a radial distance between a mobile device and an access point, with the radial distance capable of circumscribing at least a portion of a circle, such as an arc.

In block 208, the method generates the positioning assistance data of the venue using the coverage area of the one or more access points. According to aspects of the present disclosure, the positioning assistance data may be provided to determine feasible positions of a mobile device in a venue, such as venue 100. Positions may have corresponding representation(s) included as part of a schematic map of the venue. Positions may also have counterpart locations in the physical world. Positions may be defined to any level of granularity or scale.

FIG. 2B illustrates an exemplary method of determining a coverage area of one or more access points according to aspects of the present disclosure. FIG. 2B may further describe the methods performed in block 206 of FIG. 2A. As shown in FIG. 2B, in block 214, the method records the measurements of signal strength received at the each grid point with respect to the one or more access points or computes the signal strength at each grid point with respect to the one or more access points. According to aspects of the present disclosure, the method implemented in block 214 may include the method implemented in block 216, block 218, or block 220. In block 216, the method records RSSI measurements at the each grid point with respect to the one or more access points. In block 218, the method records RTT measurements at the each grid point with respect to the one or more access points. In block 220, the method records HDOP measurements at the each grid point with respect to the one or more access points.

FIG. 2C illustrates an exemplary method of generating the positioning assistance data of a venue according to aspects of the present disclosure. FIG. 2C may further describe the methods performed in block 208 of FIG. 2A. In the exemplary implementation shown in FIG. 2C, in block 222, the method obtains a coverage area of GNSS signals within the signal boundary of the venue. In block 224, the method computes a signal visibility area based at least in part on the coverage area of the one or more access points and the coverage area of GNSS signals within the signal boundary of the venue. In block 226, the method reduces the size of the positioning assistance data of the venue using the signal visibility area.

To determine whether an area is useful for WiFi based positioning, quantitative measurements may be performed. Base on quantitative measurements, an extended WiFi-positioning candidate area may be identified. This area may be represented as an extension of an indoor map. The boundary can be used to define grid point coverage of the positioning assistance data.

According to aspects of the present disclosure, a visibility area can be represented in the form of a coarse visibility area or in the form of a comprehensive visibility area. For example, a coarse visibility area may include any grid point inside an extended boundary of the venue that has a RSSI value >−85 dBm for at least one access point, or may be able to receive GNSS signal, which means this grid point may be able to observe at least one indoor access point or observe GNSS signals from a satellite. This area can be used as a base-line condition for positioning, as a grid point outside of this area may not be useful for performing WiFi and/or GNSS based positioning.

According to aspects of the present disclosure, a comprehensive visibility area may include any grid point inside the extended signal boundary of the venue that has at least 3 visible (i.e., RSSI >−85 dBm) access points, and/or HDOP (horizontal dilution of precision) value <1.5, and/or ability to receive to GNSS signal, which means WiFi based positioning and GNSS based positioning may give a reasonable result at this grid point. Note that the RSSI value of −85 dBm and/or HDOP value of 1.5 are merely examples of empirical threshold values. Other threshold values may be used based on different characteristic values of indoor and/or outdoor environments of a venue.

Based on the different approaches with the different types of visibility areas, threshold values may be chosen to identify regions with desirable WiFi coverage, HDOP value and GNSS coverage. These regions may be identified as visibility areas for positioning applications. Correspondingly grid points outside these regions can be considered as dead zones. A union of the WiFi coverage area and GNSS coverage area can be generated to identify the grid points at which the positioning assistance data may be computed and stored.

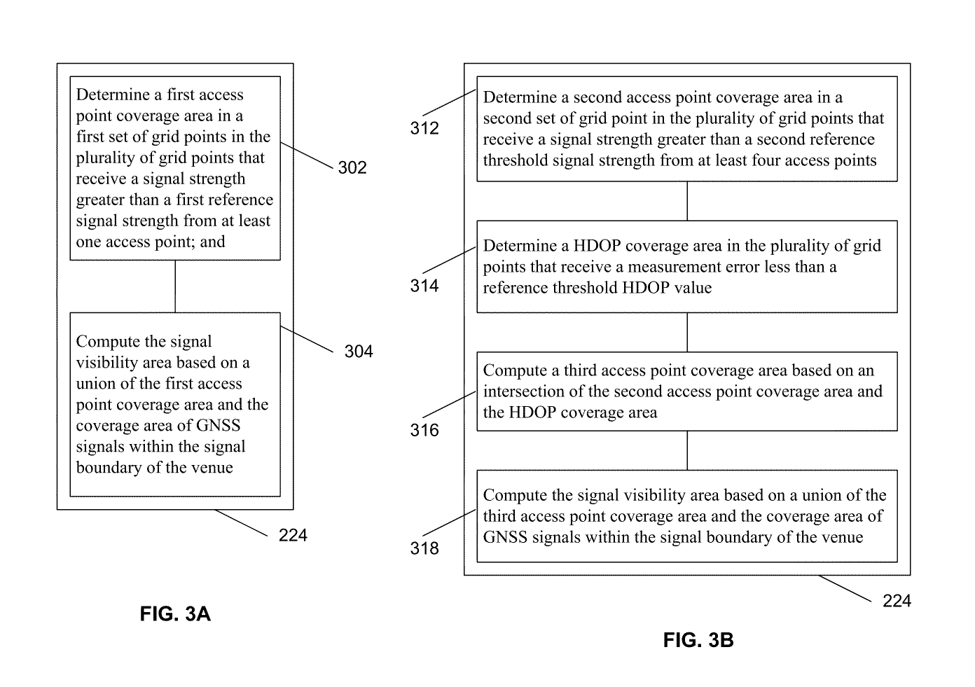

FIG. 3A illustrates an exemplary method of computing a signal visibility area of a venue according to aspects of the present disclosure. FIG. 3A may further describe a particular implementation of the methods performed in block 224 of FIG. 2C. In the exemplary method shown in FIG. 3A, in block 302, the method determines a first access point coverage area in a first set of grid points in the plurality of grid points that receive a signal strength greater than a first reference signal strength from at least one access point. In some implementations, the first reference signal strength from at least one access point may be a value of RSSI greater than −85 dBm. In other implementations, depending on specific indoor and outdoor environments of a venue, the first reference signal strength from at least one access point may be modified, for example to a value of RSSI greater than −83 dBm or −81 dBm.

In block 304, the method computes the signal visibility area based on a union of the first access point coverage area and the coverage area of GNSS signals within the signal boundary of the venue.

FIG. 3B illustrates another exemplary method of computing a signal visibility area of a venue according to aspects of the present disclosure. FIG. 3B may further describe another particular implementation of the method performed in block 224 of FIG. 2C. As shown in FIG. 3B, in block 312, the method determines a second access point coverage area in a second set of grid points in the plurality of grid points that receive a signal strength greater than a second reference threshold signal strength from at least four access points. Similar to FIG. 3A, in some implementations, the second reference signal strength from at least one access point may be a value of RSSI greater than −85 dBm. In other implementations, depending on specific indoor and/or outdoor environments of a venue, the second reference signal strength from at least one access point may be modified, for example to a value of RSSI greater than −82 dBm or −80 dBm.

In block 314, the method determines a HDOP coverage area in the plurality of grid points that receive a measurement error less than a reference threshold HDOP value. In some implementations, the reference threshold HDOP value may be a value of HDOP less than 1.5. In other implementations, based on specific indoor and/or outdoor environments of a venue, the reference threshold HDOP value may be modified, for example to a value of HDOP less than 1.4 or 1.3.

In block 316, the method computes a third access point coverage area based on an intersection of the second access point coverage area and the HDOP coverage area. In block 318, the method computes the signal visibility area based on a union of the third access point coverage area and the coverage area of GNSS signals within the signal boundary of the venue.

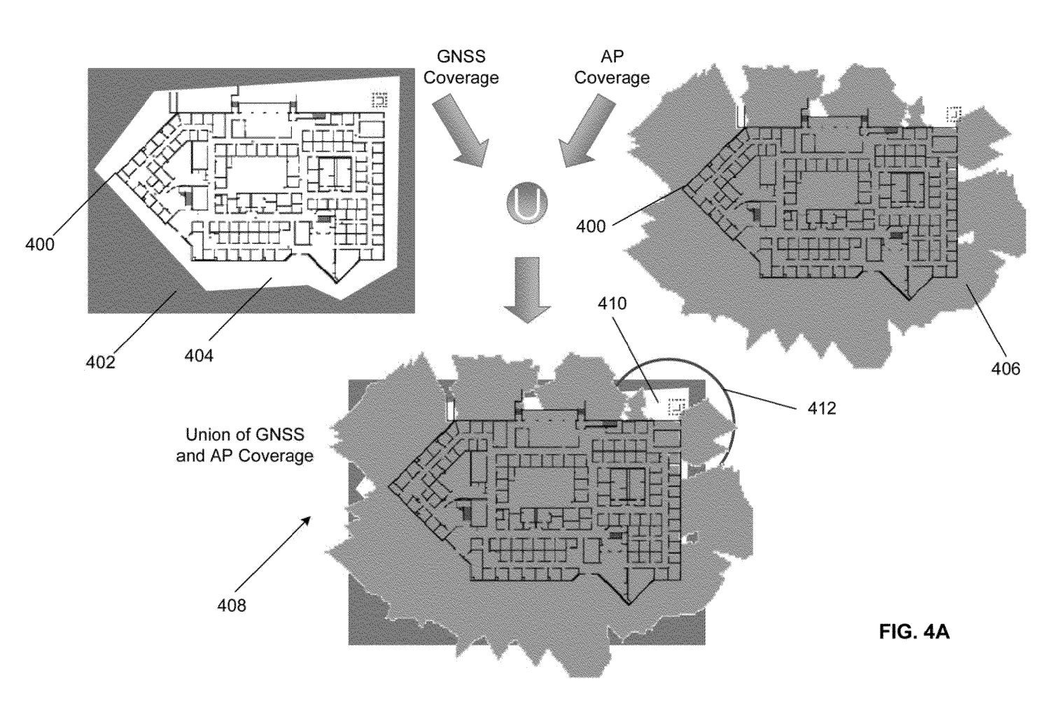

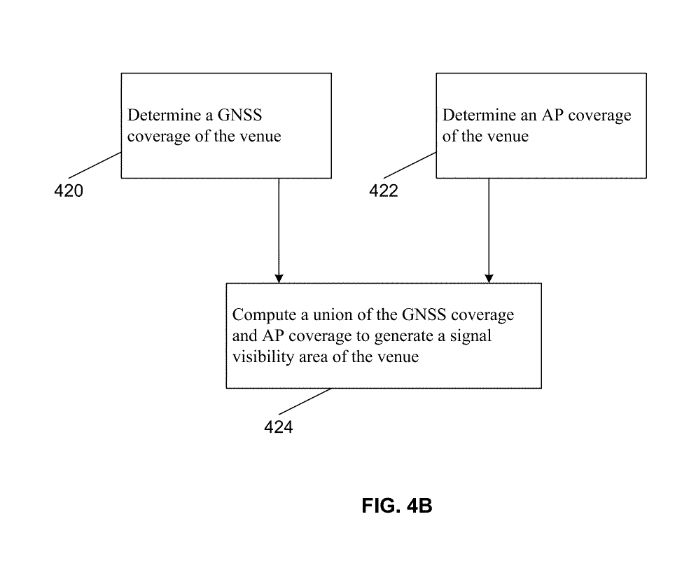

FIG. 4A is an exemplary graphical illustration of computing visibility area of a venue according to aspects of the present disclosure. In some embodiments, the GNSS coverage 402, i.e. GNSS signal that may be observed by a mobile device, for venue 400 may be measured, stored, and retrieved for subsequent use in positioning estimation and navigation applications. The measurements may be obtained by one or more mobile devices and the results of the measurements may be crowdsourced by a server. In the example shown in FIG. 4A, areas outside of venue 400 that have GNSS coverage 402 may be represented as a grey rectangle, and the areas outside of the venue 400 that do not have GNSS coverage may be shown in white 404. Note that the GNSS coverage shown in FIG. 4A for venue 400 is merely an example. Other shapes and forms of GNSS coverage may be observed, for example, GNSS coverage may be available inside of venue 400, which can be different from the case as shown in FIG. 4A.

Similarly for venue 400, access point coverage 406, i.e. WiFi signals from one or more access points that may be observed by a mobile device, may be measured, stored, and retrieved for subsequent use in positioning estimation and navigation applications. The measurements may be obtained by one or more mobile devices and the results of the measurements may be crowdsourced by a server. In the example shown in FIG. 4A, access point coverage 406 may represent an area where WiFi signals from at least one access point may be observed. In other implementations, the access point coverage 406 may be adjusted based on WiFi signals from a different number (such as 3, 5, etc.) of access points that may be observed by the mobile device. In yet other implementations, the access point coverage 406 may be simulated or calculated from the information of the one or more access points in the venue 400. For example, based on characteristics of the one or more access points obtained, the access point coverage 406 for the venue 400 may be simulated. For another example, based on a limited set of RSSI measurements at some of the grid points in the venue 400, the access point coverage 406 may be calculated by interpolating the limited set of RSSI measurements at some of the grid points to estimate the signal strength at other grid points in the venue 400.

According to aspects of the present disclosure, a visibility area 408 of venue 400 may be computed by taking a union of the GNSS coverage 402 and AP coverage 406. As shown in FIG. 4A, portions of the visibility area may be covered by GNSS signals only, other portions of the visibility area may be covered by WiFi signals only, yet other portions of the visibility area may be covered by both GNSS signals and WiFi signals. Note that there may be other areas, such as the area indicated by numeral 410 in circle 412, may be a dead zone in which neither GNSS nor WiFi signals may be observed. With the information about the dead zones in the venue, additional access points may be deployed to provide WiFi signal coverage to such dead zones. In addition, the information about the dead zones may be incorporated into algorithms that provide coverage for mobile devices to ensure smooth indoor-outdoor transition.

FIG. 4B is an exemplary flowchart of computing visibility area of a venue of FIG. 4A according to aspects of the present disclosure. In some applications, this exemplary method may be employed to provide a coarse estimation of visibility area for a venue. As shown in FIG. 4B, in block 420, the method determines a GNSS coverage of the venue (as indicated by numerals 402 and 404 in FIG. 4A). In block 422, the method determines AP coverage of the venue (as indicated by numeral 406 in FIG. 4A). In block 424, the method computes a union of the GNSS coverage and AP coverage to generate the signal visibility area for the venue 400 (as indicated by numeral 408 in FIG. 4A).

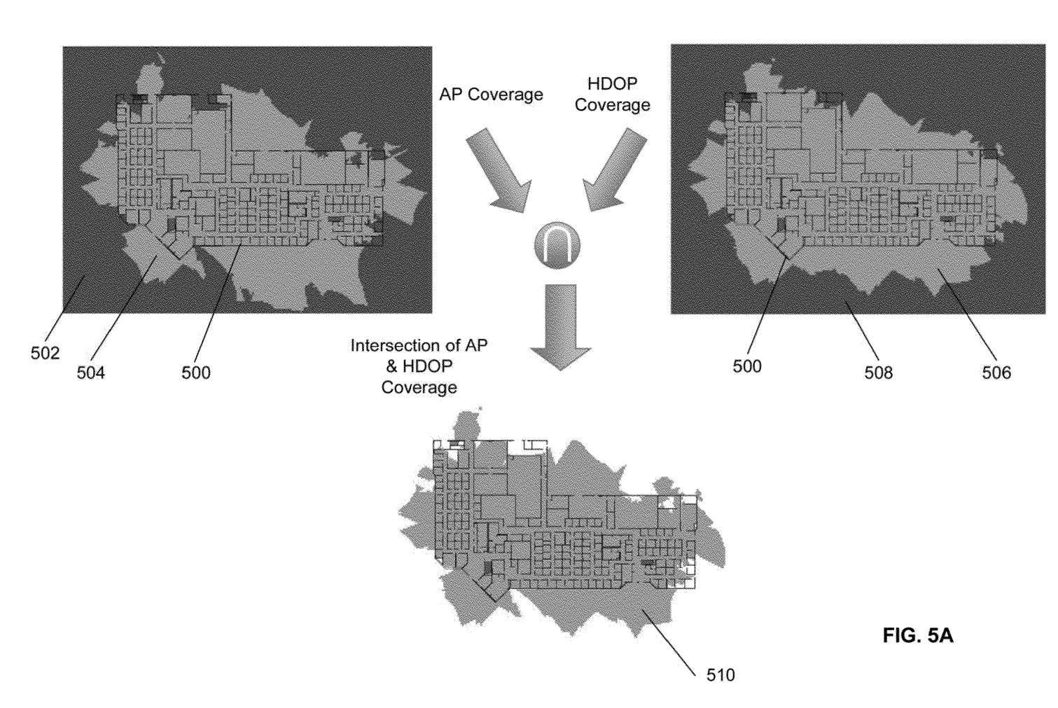

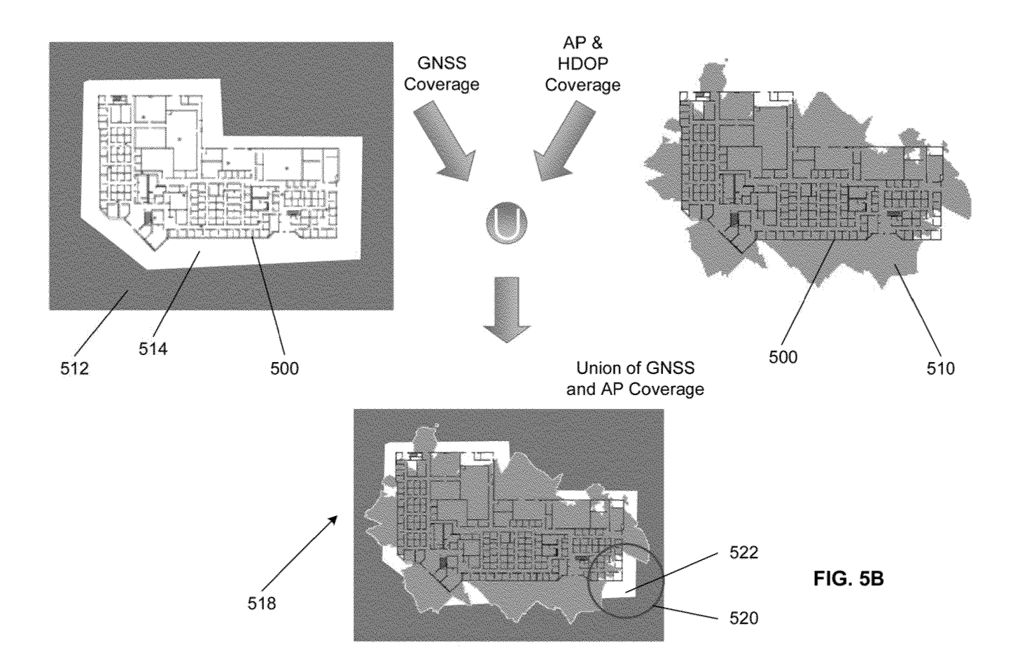

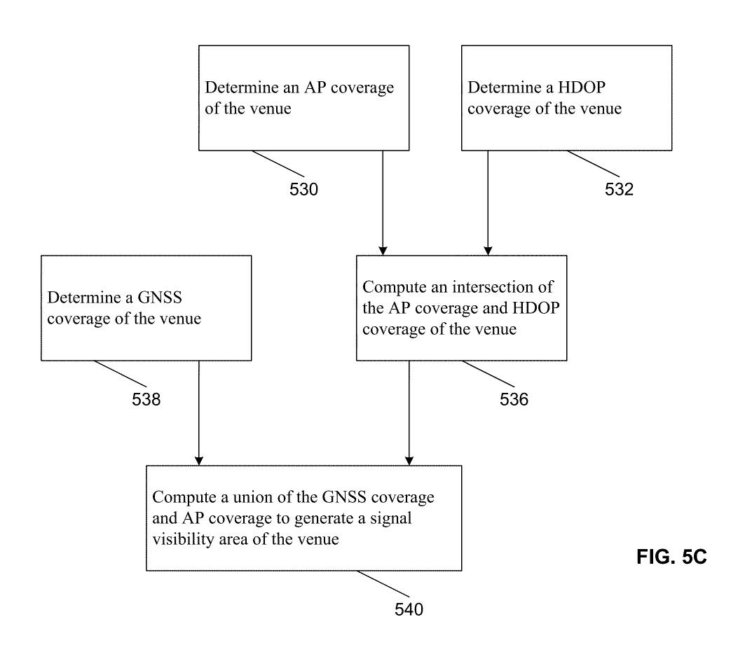

FIGS. 5A-5B is another exemplary graphical illustration of computing visibility area of a venue according to aspects of the present disclosure. In the example shown in FIG. 5A, for venue 500, area 502 indicates WiFi signals from less than four access points may be observed, and area 504 indicates WiFi signals from four or more access points may be observed by a mobile device. In other implementations, the access point coverage may be modified based on WiFi signals from a different number of access points that may be observed by the mobile device. In addition, for venue 500, area 506 indicates where measurements of HDOP value is less than 1.5, and area 508 indicates where measurements of HDOP value is equal or larger than 1.5. Area 510 indicates an area computed by an intersection of AP coverage area 504 where four or more access points may be observed and area 506 where measurements of HDOP value is less than 1.5.

In FIG. 5B, a GNSS coverage 512, i.e. GNSS signal that may be observed by a mobile device, for venue 500 may be measured, stored, and retrieved for subsequent use in positioning estimation and navigation applications. The measurements may be obtained by one or more mobile devices and the results of the measurements may be crowdsourced by a server. In the example shown in FIG. 5B, areas outside of venue 500 that have GNSS coverage 512 may be shown as a grey rectangle, and the areas outside of the venue 500 that do not have GNSS coverage may be shown in white 514. Similar to the GNSS coverage description in FIG. 4A, the GNSS coverage shown in FIG. 5B for venue 500 is merely an example. Other shapes and forms of GNSS coverage may be observed, for example, GNSS coverage may be available inside of venue 500, which can be different from the case as shown in FIG. 5B.

According to aspects of the present disclosure, a visibility area 518 of venue 500 may be computed by taking a union of the GNSS coverage 512 together with the intersection of AP and HDOP coverage 510. In the example shown in FIG. 5B, portions of the visibility area may be covered by GNSS signals only, other portions of the visibility area may be covered by WiFi signals only, yet other portions of the visibility area may be covered by both GNSS signals and WiFi signals. Note that there may be other areas, such as the area indicated by numeral 522 in circle 520, may be a dead zone in which neither GNSS nor WiFi signals may be observed. One way to address this issue may be to deploy additional access points to provide WiFi signal coverage to the dead zones. In addition, the information about the dead zones may be incorporated into algorithms to provide coverage for mobile devices to ensure smooth indoor-outdoor transition.

FIG. 5C is a flowchart of computing visibility area of a venue of FIGS. 5A-5B according to aspects of the present disclosure. In some applications, this exemplary method may be employed to provide a comprehensive estimation of visibility area for a venue. As shown in FIG. 5C, in block 530, the method determines an AP coverage of the venue (as indicated by numerals 502 and 504 in FIG. 5A). In block 532, the method determines HDOP coverage of the venue (as indicated by numerals 506 and 508 in FIG. 5A). In block 536, the method computes an intersection of AP coverage and HDOP coverage to generate a comprehensive AP coverage for venue 500 (as indicated by numeral 510 in FIG. 5A). In block 538, the method determines a GNSS coverage of the venue (as indicated by numerals 512 and 514 in FIG. 5B). In block 540, the method computes a union of the GNSS coverage 512 and the comprehensive AP coverage 510 to generate the signal visibility area (as indicated by numeral 518 in FIG. 5B) for venue 500.

According to aspects of the present disclosure, identifying the visibility area based on WiFi and GNSS coverage for a venue can have a number of benefits. For example, the visibility area may be used to 1) reduce the size of positioning assistance data without losing useful information; 2) reduce the workload of gathering nearby outdoor WiFi data for a building; and 3) enable effective switch between GPS and WiFi based positioning for smooth transition between the indoor environment and the outdoor environment.

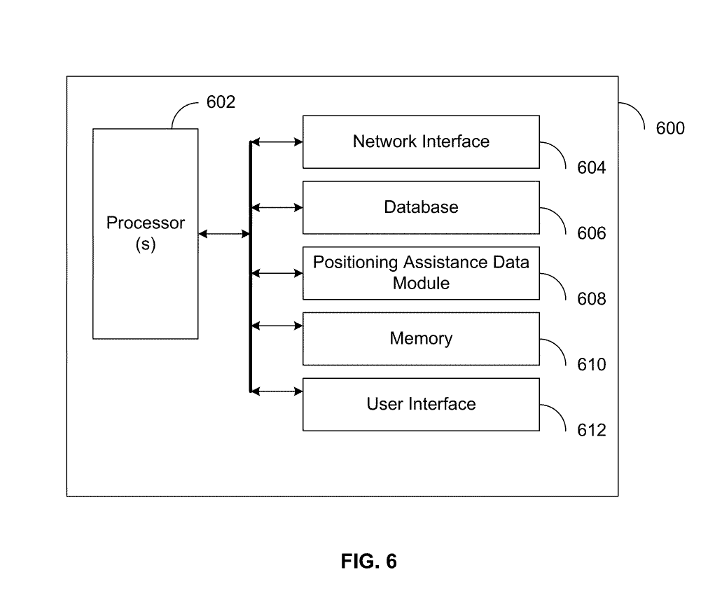

FIG. 6 illustrates an exemplary apparatus for generating positioning assistance data according to aspects of the present disclosure. In the example shown in FIG. 6, apparatus 600 may include one or more processors 602, network interface 604, database 606, positioning assistance data module 608, memory 610, and user interface 612. The one or more processors 602 can be configured to control operations of the apparatus 600. The network interface 604 can be configured to communicate with a network (not shown), which may be configured to communicate with servers, computers, and mobile devices on the network. Database 606 can be configured to store information of access points in the venue as well as maps, directories, floor plans, searchable terms, images, and other information of the venue. The one or more processors 602 and/or the positioning assistance data module 608 can be configured to implement methods of generating positioning assistance data. For example, working with the processor(s) 602, the positioning assistance data module 608 can be configured to implement methods described in association with FIGS. 2A-2C, FIGS. 3A-3B, FIG. 4B and FIG. 5C. Memory 610 can be configured to store program codes, instructions, and data for the apparatus 600. User interface 612 may be configured to enable interactions between apparatus 600 and a user. According to aspects of the present disclosure, the apparatus 600 may be implemented as a part of a server. In that implementation, the positioning assistance data may be communicated to mobile devices via the network interface 604. According to other aspects of the present disclosure, the apparatus 600 may be implemented as a part of a mobile device. In that implementation, the positioning assistance data may be used by the mobile device and/or may be communicated to other mobile devices or servers via the network interface 604. In yet other implementations, some blocks of the apparatus 600 may be implemented in a mobile device and some blocks of the apparatus 600 may be in a server. These implementations or any combinations thereof are within the scope of the present disclosure.

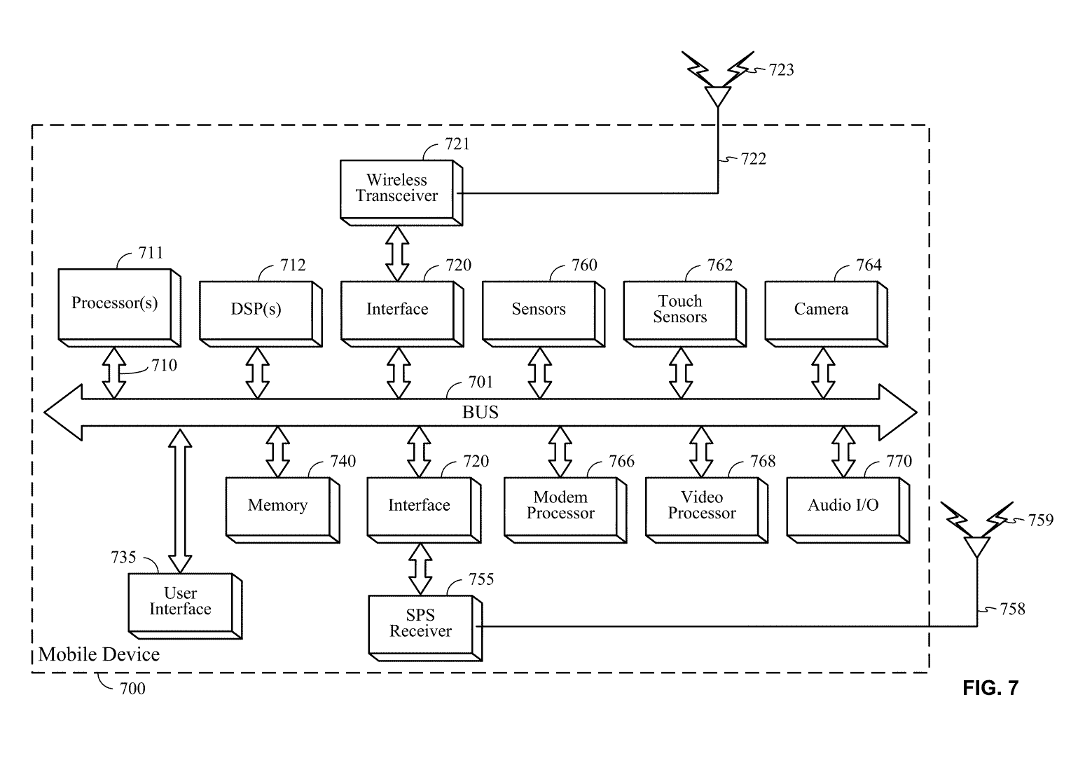

FIG. 7 illustrates an exemplary block diagram of a mobile device according to aspects of the present disclosure. As shown in FIG. 7, mobile device 700 may comprise one or more features of the one or more mobile devices as described in association with FIG. 1 to FIG. 6. In certain embodiments, mobile device 700 may also comprise a wireless transceiver 721 which is capable of transmitting and receiving wireless signals 723 via wireless antenna 722 over a wireless communication network. Wireless transceiver 721 may be connected to bus 701 by a wireless transceiver bus interface 720. Wireless transceiver bus interface 720 may, in some embodiments be at least partially integrated with wireless transceiver 721. Some embodiments may include multiple wireless transceivers 721 and wireless antennas 722 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth, etc.

According to aspects of the present disclosure, wireless transceiver 721 may comprise a transmitter and a receiver. The transmitter and the receiver may be implemented to share common circuitry, or may be implemented as separate circuits. Mobile device 700 may also comprise SPS receiver 755 capable of receiving and acquiring SPS signals 759 via SPS antenna 758. SPS receiver 755 may also process, in whole or in part, acquired SPS signals 759 for estimating a location of mobile device 700. In some embodiments, processor(s) 711, memory 740, DSP(s) 712 and/or specialized processors (not shown) may also be utilized to process acquired SPS signals, in whole or in part, and/or calculate an estimated location of mobile device 700, in conjunction with SPS receiver 755. Storage of SPS or other signals for use in performing positioning operations may be performed in memory 740 or registers (not shown).

Also shown in FIG. 7, mobile device 700 may comprise digital signal processor(s) (DSP(s)) 712 connected to the bus 701 by a bus interface 710, processor(s) 711 connected to the bus 701 by a bus interface 710 and memory 740. Bus interface 710 may be integrated with the DSP(s) 712, processor(s) 711 and memory 740. In various embodiments, functions may be performed in response execution of one or more machine-readable instructions stored in memory 740 such as on a computer-readable storage medium, such as RAM, ROM, FLASH, or disc drive, just to name a few example. The one or more instructions may be executable by processor(s) 711, specialized processors, or DSP(s) 712. Memory 740 may comprise a non-transitory processor-readable memory and/or a computer-readable memory that stores software code (programming code, instructions, etc.) that are executable by processor(s) 711 and/or DSP(s) 712 to perform functions described herein. In a particular implementation, wireless transceiver 721 may communicate with processor(s) 711 and/or DSP(s) 712 through bus 701 to enable mobile device 700 to be configured as a wireless mobile device as discussed above. Processor(s) 711 and/or DSP(s) 712 may execute instructions to execute one or more aspects of processes/methods discussed above in connection with FIGS. 2A-2C, FIGS. 3A-3B, FIG. 4B and FIG. 5C.

Also shown in FIG. 7, a user interface 735 may comprise any one of several devices such as, for example, a speaker, microphone, display device, vibration device, keyboard, touch screen, etc. In a particular implementation, user interface 735 may enable a user to interact with one or more applications hosted on mobile device 700. For example, devices of user interface 735 may store analog or digital signals on memory 740 to be further processed by DSP(s) 712 or processor 711 in response to action from a user. Similarly, applications hosted on mobile device 700 may store analog or digital signals on memory 740 to present an output signal to a user. In another implementation, mobile device 700 may optionally include a dedicated audio input/output (I/O) device 770 comprising, for example, a dedicated speaker, microphone, digital to analog circuitry, analog to digital circuitry, amplifiers and/or gain control. In another implementation, mobile device 700 may comprise touch sensors 762 responsive to touching or pressure on a keyboard or touch screen device.

Mobile device 700 may also comprise a dedicated camera device 764 for capturing still or moving imagery. Dedicated camera device 764 may comprise, for example an imaging sensor (e.g., charge coupled device or CMOS imager), lens, analog to digital circuitry, frame buffers, etc. In one implementation, additional processing, conditioning, encoding or compression of signals representing captured images may be performed at processor 711 or DSP(s) 712. Alternatively, a dedicated video processor 768 may perform conditioning, encoding, compression or manipulation of signals representing captured images. Additionally, dedicated video processor 768 may decode/decompress stored image data for presentation on a display of mobile device 700.

Mobile device 700 may also comprise sensors 760 coupled to bus 701 which may include, for example, inertial sensors and environment sensors. Inertial sensors of sensors 760 may comprise, for example accelerometers (e.g., collectively responding to acceleration of mobile device 700 in three dimensions), one or more gyroscopes or one or more magnetometers (e.g., to support one or more compass applications). Environment sensors of mobile device 700 may comprise, for example, temperature sensors, barometric pressure sensors, ambient light sensors, and camera imagers, microphones, just to name few examples. Sensors 760 may generate analog or digital signals that may be stored in memory 740 and processed by DPS(s) or processor 711 in support of one or more applications such as, for example, applications directed to positioning or navigation operations.

In a particular implementation, mobile device 700 may comprise a dedicated modem processor 766 capable of performing baseband processing of signals received and down-converted at wireless transceiver 721 or SPS receiver 755. Similarly, dedicated modem processor 766 may perform baseband processing of signals to be up-converted for transmission by wireless transceiver 721. In alternative implementations, instead of having a dedicated modem processor, baseband processing may be performed by a processor or DSP (e.g., processor 711 or DSP(s) 712).

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof. In addition, some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense, or any combination thereof, such as A and B, B and C, A and C. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

We claim:

1. A method of generating a positioning assistance data of a venue, comprising:
obtaining a map and corresponding descriptions of one or more access points in the venue, the venue having a signal boundary which extends beyond an indoor area of the venue, the signal boundary being partitioned into a plurality of grid points, wherein each grid point in the plurality of grid points represents an area within the signal boundary of the venue;
determining a coverage area of the one or more access points based on measurements of signal strength received from the one or more access points within the signal boundary of the venue, wherein the coverage area of the one or more access points meets a criterion of signal strength received from at least one access point, and wherein the coverage area includes some grid points in the indoor area of the venue and some grid points in an outdoor area of the venue; and
generating the positioning assistance data of the venue using the coverage area of the one or more access points.

2. The method of claim 1, wherein the determining the coverage area of the one or more access points in the venue comprises:
recording the measurements of signal strength received at the each grid point with respect to the one or more access points or computing the signal strength at each grid point with respect to the one or more access points.

3. The method of claim 2, wherein the recording the measurements of signal strength received at the each grid point with respect to the one or more access points or computing the signal strength at each grid point with respect to the one or more access points comprise at least one of:
recording or computing RSSI measurements at the each grid point with respect to the one or more access points;
recording or computing RTT measurements at the each grid point with respect to the one or more access points; or
recording or computing HDOP measurements at the each grid point with respect to the one or more access points.

4. The method of claim 2, wherein the generating the positioning assistance data of the venue comprises:
obtaining a coverage area of GNSS signals within the signal boundary of the venue;
computing a signal visibility area based at least in part on the coverage area of the one or more access points and the coverage area of GNSS signals within the signal boundary of the venue; and
reducing a size of the positioning assistance data of the venue using the signal visibility area.

5. The method of claim 4, wherein the computing the signal visibility area comprises:
determining a first access point coverage area in a first set of grid points in the plurality of grid points that receive a signal strength greater than a first reference signal strength from the at least one access point; and
computing the signal visibility area based on a union of the first access point coverage area and the coverage area of GNSS signals within the signal boundary of the venue.

6. The method of claim 4, wherein the computing the signal visibility area further comprises:
determining a second access point coverage area in a second set of grid points in the plurality of grid points that receive a signal strength greater than a second reference threshold signal strength from at least four access points;
determining a HDOP coverage area in the plurality of grid points that receive a measurement error less than a reference threshold HDOP value; and
computing a third access point coverage area based on an intersection of the second access point coverage area and the HDOP coverage area.

7. The method of claim 6, further comprising:
computing the signal visibility area based on a union of the third access point coverage area and the coverage area of GNSS signals within the signal boundary of the venue.

8. The method of claim 6, wherein the second reference threshold signal strength has a RSSI value greater than −85 dBm; and wherein the reference threshold HDOP value has a HDOP value less than 1.5.

9. An apparatus, comprising:
one or more processors that include processing logic, the processing logic comprises
logic configured to obtain a map and corresponding descriptions of one or more access points in the venue, the venue having a signal boundary which extends beyond an indoor area of the venue, the signal boundary being partitioned into a plurality of grid points, wherein each grid point in the plurality of grid points represents an area within the signal boundary of the venue;
logic configured to determine a coverage area of the one or more access points based on measurements of signal strength received from the one or more access points within the signal boundary of the venue, wherein the coverage area of the one or more access points meets a criterion of signal strength received from at least one access point, and wherein the coverage area includes some grid points in the indoor area of the venue and some grid points in an outdoor area of the venue; and
logic configured to download information of the coverage area of the one or more access points to one or more mobile devices.

10. The apparatus of claim 9, wherein the logic configured to determine the coverage area of the one or more access points in the venue comprises:
logic configured to record the measurements of signal strength received at the each grid point with respect to the one or more access points or to compute the signal strength at each grid point with respect to the one or more access points.

11. The apparatus of claim 10, wherein the logic configured to record the measurements of signal strength received at the each grid point with respect to the one or more access points comprises at least one of:
logic configured to record or compute RSSI measurements at the each grid point with respect to the one or more access points;
logic configured to record or compute RTT measurements at the each grid point with respect to the one or more access points; or
logic configured to record or compute HDOP measurements at the each grid point with respect to the one or more access points.

12. The apparatus of claim 10, further comprises:
logic configured to obtain a coverage area of GNSS signals within the signal boundary of the venue;
logic configured to compute a signal visibility area based at least in part on the coverage area of the one or more access points and the coverage area of GNSS signals within the signal boundary of the venue; and
logic configured to reduce a size of a positioning assistance data of the venue using the signal visibility area.

13. The apparatus of claim 12, wherein the logic configured to compute the signal visibility area comprises:
logic configured to determine a first access point coverage area in a first set of grid points in the plurality of grid points that receive a signal strength greater than a first reference signal strength from the at least one access point; and
logic configured to compute the signal visibility area based on a union of the first access point coverage area and the coverage area of GNSS signals within the signal boundary of the venue.

14. The apparatus of claim 12, wherein the logic configured to compute the signal visibility area further comprises:
logic configured to determine a second access point coverage area in a second set of grid points in the plurality of grid points that receive a signal strength greater than a second reference threshold signal strength from at least four access points;
logic configured to determine a HDOP coverage area in the plurality of grid points that receive a measurement error less than a reference threshold HDOP value;
logic configured to compute a third access point coverage area based on an intersection of the second access point coverage area and the HDOP coverage area; and
logic configured to compute the signal visibility area based on a union of the third access point coverage area and the coverage area of GNSS signals within the signal boundary of the venue.

15. A computer program product comprising non-transitory medium storing instructions for execution by one or more computer systems, the instructions comprising:
instructions for obtaining a map and corresponding descriptions of one or more access points in the venue, the venue having a signal boundary which extends beyond an indoor area of the venue, the signal boundary being partitioned into a plurality of grid points, wherein each grid point in the plurality of grid points represents an area within the signal boundary of the venue;
instructions for determining a coverage area of the one or more access points based on measurements of signal strength received from the one or more access points within the signal boundary of the venue, wherein the coverage area of the one or more access points meets a criterion of signal strength received from at least one access point, and wherein the coverage area includes some grid points in the indoor area of the venue and some grid points in an outdoor area of the venue; and
instructions for generating a positioning assistance data of the venue using the coverage area of the one or more access points.

16. The computer program product of claim 15, wherein the instructions for determining the coverage area of the one or more access points in the venue comprises:
instructions for recording the measurements of signal strength received at the each grid point with respect to the one or more access points or computing the signal strength at each grid point with respect to the one or more access points.

17. The computer program product of claim 16, wherein the instructions for recording the measurements of signal strength received at the each grid point with respect to the one or more access points comprises at least one of:
instructions for recording or computing RSSI measurements at the each grid point with respect to the one or more access points;
instructions for recording or computing RTT measurements at the each grid point with respect to the one or more access points; or
instructions for recording or computing HDOP measurements at the each grid point with respect to the one or more access points.

18. The computer program product of claim 16, wherein the instructions for generating the positioning assistance data of the venue comprises:
instructions for obtaining a coverage area of GNSS signals within the signal boundary of the venue;
instructions for computing a signal visibility area based at least in part on the coverage area of the one or more access points and the coverage area of GNSS signals within the signal boundary of the venue; and
instructions for reducing a size of the positioning assistance data of the venue using the signal visibility area.

19. The computer program product of claim 18, wherein the instructions for computing the signal visibility area comprises:
instructions for determining a first access point coverage area in a first set of grid points in the plurality of grid points that receive a signal strength greater than a first reference signal strength from the at least one access point; and
instructions for computing the signal visibility area based on a union of the first access point coverage area and the coverage area of GNSS signals within the signal boundary of the venue.

20. The computer program product of claim 18, wherein the instructions for computing the signal visibility area further comprises:
instructions for determining a second access point coverage area in a second set of grid points in the plurality of grid points that receive a signal strength greater than a second reference threshold signal strength from at least four access points;
instructions for determining a HDOP coverage area in the plurality of grid points that receive a measurement error less than a reference threshold HDOP value;
instructions for computing a third access point coverage area based on an intersection of the second access point coverage area and the HDOP coverage area; and
instructions for computing the signal visibility area based on a union of the third access point coverage area and the coverage area of GNSS signals within the signal boundary of the venue.
